(19) United States
(12) Patent Application Publication
(10) Pub. No.: US 2005/0274663 A1
(43) Pub. Date: Dec. 15, 2005

(54) [Air and Water Conditioning System and Filter Media]

(76) Inventor: Lipa Leon Roitman, Dayton, OH (US)

Correspondence Address: LIPA ROITMAN, 300 OTTERBEIN AVENUE, DAYTON, OH, 45406, US

(21) Appl. No.: 10/709,694

(22) Filed: May 24, 2004

(51) Int. Cl. B01D 36/00; B01D 15/00; B01D 37/00

(52) U.S. Cl. 210/252; 422/24; 422/22; 210/644; 210/767; 210/791; 210/805; 210/175; 210/259; 210/263; 210/294

(57) ABSTRACT

Disclosed is an air-water-catalyst-UV light contacting, air heating and cooling, humidifying and dehumidifying CHAMBER, which receives water that continuously recirculates through the water filtering, heating and cooling, (and deionizing) loop, which gets fresh outdoors air through the energy-efficient heat exchanger, which generates water from the atmospheric moisture, which stores and recirculates pure water through potable water holding tank, and to which is connected a novel design energy-efficient self-regulating steam distillation apparatus. Also, a water filtration system utilizing zwitterionic polymers as ion exchange and salt-absorbing and filtration media. Also disclosed are novel ionic and zwitterionic polymers, derived from cellulose.

### BACKGROUND OF INVENTION

An indoor environment should be a refuge from the outside world, which protects man from the elements. However, there are many indoor pollutants, smoking is probably one of the worst ones, and many others, that attack a person indoors, including cooking odors and the outgassing of fumes and solvents from paints, glues, floor carpeting, building materials, fungi, mites, dust, etc. Some pollutants are highly allergic, and cause numerous cold-like symptoms, especially in winter, when people spend more time indoors. These pollutants can have serious impact on quality of life.

An indoor environment is usually kept relatively air tight to increase heating or air conditioning efficiency. But without an exchange of substantial indoor air volume with fresh outside air, the air inside the room becomes increasingly polluted with the passage of time and depleted of oxygen as a result of human breathing, gas cooking and heating, with simultaneous increase of levels of carbon dioxide, and at times even more dangerous carbon monoxide.

Thus, it would be highly desirable to provide an energy efficient way to exchange the indoor and outdoor air.

Furthermore, additional air purification is also needed for the incoming outdoor air, since it is also often polluted with pollen, smog, and vehicle exhaust fumes.

Furthermore, the incoming outdoors air in summer is often very hot and humid, and requires removal of humidity for people to feel comfortable. In winter the opposite is true, and the incoming outdoors air often needs humidifying. The extremely dry air in cold winter also causes skin and throat dryness, itchiness, susceptibility for infections, and other health problems.

Furthermore, in hot arid climates there is often a shortage of potable water. At such locations there is a value to the water that is generated as a result of normal air conditioning operations. The outdoors hot air contains water vapors, sometimes a large amount, and it could be condensed into potable water.

Furthermore, in some areas of the country the municipal water contains high levels of toxic minerals like arsenic, and man-made pollutants, like perchlorate ions, and a cost-effective method of removing them from drinking water is needed.

Furthermore, especially in desert climates there is a large difference between day and night temperatures, sometimes requiring cooling in daytime and heating nights. It would be advantageous to store the heat during daytime and releasing it nights.

Therefore there is a need for an apparatus and a method that is capable at the same time of 1) introducing fresh clean air from outdoors in an energy efficient way, i.e. without losing the indoor heat or cold, 2) reducing indoor air pollutants, 3) heating or cooling the indoor air, 4) removing excess humidity in hot weather and adding humidity to the indoor air in cold weather, 5) converting water condensed as a result of air conditioning action in hot and humid climates into clean potable water, 6) providing a storage reservoir for the clean drinking water, and further purifying the municipal water, by removing byproducts of chlorinating and other persistent pollutants, 7) absorbing the daytime heat and releasing it at night, and 8) being the integral and low-maintenance part of the total energy efficient home heating and air conditioning system.

U.S. patent application 20040020363 LaFerriere, et al. reviews methods of indoor air purification. I believe the method of this invention is different and has a number of advantages. U.S. Pat. No. 6,582,563 to Adam, et al. discusses methods of water purification by distillation. I believe the distillation method of this invention is different and much simple, is self-regulating, and has a number of other advantages.

### SUMMARY OF INVENTION

The apparatus is thus disclosed that exchanges the outdoors and indoors air while efficiently exchanging the heat; the outdoors air moves indoors and indoors air outdoors through the heat exchanger built to take advantage of the energy efficient counter-flow design,

The apparatus is thus disclosed, in the heart of which there is an air-water-catalyst-UV light contacting, air heating and cooling, humidifying and dehumidifying CHAMBER (herein the CHAMBER),
which receives water that continuously recirculates through the water filtering, heating and cooling, (and deionizing) loop,
which gets fresh outdoors air through the energy-efficient HEAT EXCHANGER,
which stores and recirculates pure water through potable water holding tank, and to which is connected a novel design energy-efficient self-regulating steam distillation apparatus.

The CHAMBER filters, purifies, and disinfects the air, traps the particulate pollutants in water droplets, and oxidizes the pollutants using a combination of UV light and solid inorganic catalysts in contact with the water-air mist in the CHAMBER, then further traps the acidic oxidation by-products by percolating through the limestone bed. The CHAMBER purifies the air continuously, by recirculating the indoor air, and also receives and cleans fresh outdoors air through an energy efficient heat exchanger of counterflow design.

Two water filters continuously purify the water by circulating the water between the CHAMBER and the water holding tank. The same CHAMBER also heats or cools the air, and humidifies or dehumidifies it, through controlling the temperature of the water. In this capacity it serves as a sole heat exchanger, or supplements the conventional one.

The water holding tank is connected to the municipal water system and has water level control means. Its water is continuously recirculating through the water purification loop. It also collects additional water removed from the air when the CHAMBER is acting as dehumidifier, and makes it available for drinking. The water holding tank also provides potable water storage for emergencies, and also serves as a heat sink, absorbing heat during the day, and releasing it at night.

Also attached to the water holding tank is a novel and simple self-regulating and energy efficient distillation apparatus built on the counter-flow heat exchanger principle that steam distills the water, removing toxic inorganic ions, like arsenic, lead and perchlorate.

The water, before entering the CHAMBER goes through an instant water cooler/heater in order to control the air temperature and humidity. This allows fast response and close control over the temperature and humidity. The temperature, humidity, the ratio between the recirculating and outdoors air, the rates of the air and water circulation, and the volume of the air-water contacting space are centrally controlled, receiving signals from the air quality and other sensors. Back-flushing of the particulate filters and regeneration of the ion exchange and activated carbon filters is also performed automatically.

Furthermore a novel filtration and ion exchange media, made from a renewable resource, cellulose or crosslinked starch, and capable of removing toxic ions like lead, arsenic, perchlorate, and the oxidized by-products of pollutants is disclosed.

The height of the water contacting inlet relative to the total chamber height is adjustable, to further regulate the total humidity that is added or removed from the air, and decouple the humidity control from the heating or cooling controls. Alternatively, the direction of the water streams can be adjusted. To increase the humidity during the heating cycle the contacting head is raised, to decrease the humidity it is lowered. When the contacting head is lowered, the part of the chamber above the contacting head condenses extra vapors and catches water droplets. Additional control is provided by controlling water droplet size. Smaller droplets increase humidity, and larger decrease it.

### BRIEF DESCRIPTION OF DRAWINGS

FIG. 1 and FIG. 2 show schematics of the apparatus according to the invention. The distillation apparatus is shown only in outline.

FIGS. 3 through 6 show schematics of a distillation apparatus of the invention in a number of different embodiments.

### DETAILED DESCRIPTION

The apparatus of this invention is comprising of

A. a counter-flow principle air-to-air heat exchanger 100 connecting the outdoor and indoor air through a plurality of channels or tubes within and along the length of that heat exchanger, such as those available commercially, or custom made, wherein each channel where the air flows in one direction is in contact with the channels where the air is flowing in the opposite direction,
means 110 to move the air from indoors to outdoors through some of the channels, while simultaneously moving about the same amount of air in the opposite direction through other channels of the heat exchanger 100,
means 120 to physically separate and distance the air inlets and outlets on the outdoor end of heat exchanger to prevent the re-intake of the exhausted air,
the heat exchanging air duct is preferably inclined towards the indoors in order to collect the water condensed in hot humid weather,

B. An air-purifying, air humidifying or dehumidifying, and air cooling or heating, heat exchanging air-water contacting chamber 200 and means of contacting the incoming air from outdoors or indoors with the falling water inside that chamber, comprising a substantially vertical water-impermeable chamber with water droplets creating, or an air-water mixing devices 270, and further comprising of
the optional baffles 260, rocks 280 or other like fillings to facilitate contacting the air and the water and to increase the contact surface area, and are made from inorganic metal oxide titania or vanadium-treated titania, which is capable to catalyze the gas-solid photocatalytic oxidation in which the air stream is brought in contact with a titania-based catalyst and near-ultraviolet (UV) light. The UV light activates the catalyst, producing oxidizing radicals. The impurities are completely destroyed to carbon dioxide and water in an oxidation reaction that occurs at or near room temperature.
a vent and the valve 210 for the air incoming from the outdoors through the heat exchanger 100, a vent and the valve 220 for the incoming recirculating indoors air, or three-way vent and a three-way valve, allowing variable mixing of outdoor and the indoor air entering the chamber,
a vent 250 for the air exiting the chamber towards indoors or towards the air distributing ductwork,
means to move the air through the chamber, which could be an electric fan, or a fan powered by the stream of water going through the chamber, or Venturi-effect air-pumping device powered by the water stream,
a connection 230 for the incoming water to the chamber, which receives water from the tank 300 through the water heater/cooler 360.
a connection 240 for the outgoing water from the chamber, which connects in turn to the water filter 355, which connects in turn to the water tank 300,
a water filter 350, for removing particulate and other contaminants from the circulating water. In the preferred embodiment it has capability for regenerating by backflushing, or by other means.

In preferred embodiment the water filtration system 350 is located on the bottom of a water contacting chamber, and is made to be an integral part of it.

In the preferred embodiment the water filtration system 350 is located above or on top of the water holding tank.

In yet another alternative embodiment the water filtration system is located on a bottom of a water contacting chamber, which is above or sits on top of a water holding tank, and is optionally made to be an integral part of it.

In another embodiment the water heater and cooler are made integral with the air/heat exchanger, and are located near the outside wall,

In another embodiment the water heater and cooler are made integral with the air/heat exchanger, and are located near the outside wall.

In yet another embodiment the air/heat exchanger, water contacting chamber, the water filtration system, water heater and cooler and other devices are all made integral with each other.

The water filtration system can comprise of a multi-layer or mixed bed structure with rocks, gravel, coarse sand, regular or partially calcined limestone, marble, chalk, dolomite, apatite, mica, clay, hydrotalcite or other minerals containing carbonates or phosphates of calcium, magnesium or aluminum, and a water-permeable membrane or fiber bed underneath. Preferably such minerals create slightly basic pH, to absorb the acidic pollutants and the oxidation by-products.

The bottom of the water contacting chamber is also connected to a water source 288 or has a pump reversing switch to reverse the water flow, and a vibrator to shake the filter beds in order to dislodge the settled and trapped contaminants from the filter particles during periodic back-flushing of the filters, and with heating element to heat the water during the back-flushing.

In addition, activated carbon, reverse osmosis or any other known filter can be used to filter the water. Special filters can be used to remove specific undesirable contaminants present in the local municipal water or in the air, such as dissolved salts, halogenated contaminants, arsenic, lead, perchlorate, etc.

Especially suitable for such filtration purpose are the ionically modified polymers, and especially including the novel polymers derived from cellulose, crosslinked starch, chitine and chitosan, or other polysaccharides, that have a capacity for ion exchange. In one embodiment the water-permeable membrane or fiber filter beds for purification or filtration of water are obtained by cyanopropylation of cellulose films or fibers by addition of aqueous NaOH to cellulose suspended in acrylonitrile, followed by reduction, especially hydrogenation, which converts the nitrile group to amine. The amine such formed can be further quaternized by alkylation with methyl iodide, dimethyl sulphate and other alkylating agents.

The zwitterionically modified fibers or films can also be made by reacting polyaziridine or polyvinylpyridine or ethylenediamine with carboxymethyl cellulose, and heating to crosslink, then reacting with the alkylating agent, or by reacting polyaziridine or polyvinylpyridine or ethylenediamine with the alkylating agent, followed by mixing with carboxymethyl cellulose and heating to crosslink.

Alternative route to such ionically modified polymers is by the reaction of films or fibers from cellulose, starch, carboxymethylcellulose, and other natural or modified polysaccharides with (a) toluenesulphonyl chloride, thionyl chloride, or phosphorous oxychloride, followed by (b) the hydrohalogenation to obtain halogen-modified polysaccharides, followed by (c) amination with ammonia or amines, to obtain amino-functional polysaccharides, followed by (d) quaternization with methyl iodide, dimethyl sulphate, 2-chloroacetic acid, or other alkylating agents or mixtures of agents.

The polymers thus obtained are optionally further modified by addition of bromine water to oxidize the C(6)carbinol to carboxyl group. Alternatively, such aminofunctional cellulose and carboxy-functional one, like carboxymethyl cellulose CMC can be made separately and mixed together to make a filter. Still another possibility is to use crosslinked CMC as a substrate for introduction of cationic side groups. Such zwitterionic polymers act as ion exchange polymers, and are effective in removing from water ionic impurities, such as partially oxidized pollutants, perchlorate, lead, cadmium and arsenic. Alternatively, other known or commercially available polymers can be used.
means of dispersing or pulverizing the water to create a mist or contacting of water particles within the chamber, which can in one embodiment comprise of Venturi-effect contacting head, which effectively mixes and disperses air and water, or other like dispersing device.
means to contain such water mist within the chamber,
an optional limestone or other mineral filling in the chamber for percolating the air-water mixture through it, which percolation emulates the water purification process in the nature.
UV light source or sources 600 to irradiate the water in the contacting chamber to disinfect the air, create ozone, and promote oxidation of pollutants by air, which are helped by the reflective coating on the chamber inner walls for maximal light absorption by the air-water mix,
air ionizer and ozone generator 700 in the chamber air intake path, to create an electric charge potential between the incoming air and the water in the chamber, which promotes particulate removal, and create ozone from oxygen in the air,

C. A water tank 300, connected to the municipal water source 310, with one or more means to monitor and control the water level in the tank 320, and which is also connected to the water contacting chamber 200 through the inlet 330 and outlet 340, with means to establish a circulation pattern of movement of water in the tank, and circulation between the tank and the water contacting chamber,
means 350 to continuously filter the water returning to the tank 300 from the contacting chamber 200 to remove pollutants,
heater/cooler means 360 to cool or heat the water flowing from the tank into the contacting chamber 200 using electric, gas, oil, solar energy, heat-pump, or another known method. In the less preferred alternative embodiment the holding tank is heated or cooled directly, through the heater/cooler 360-2,

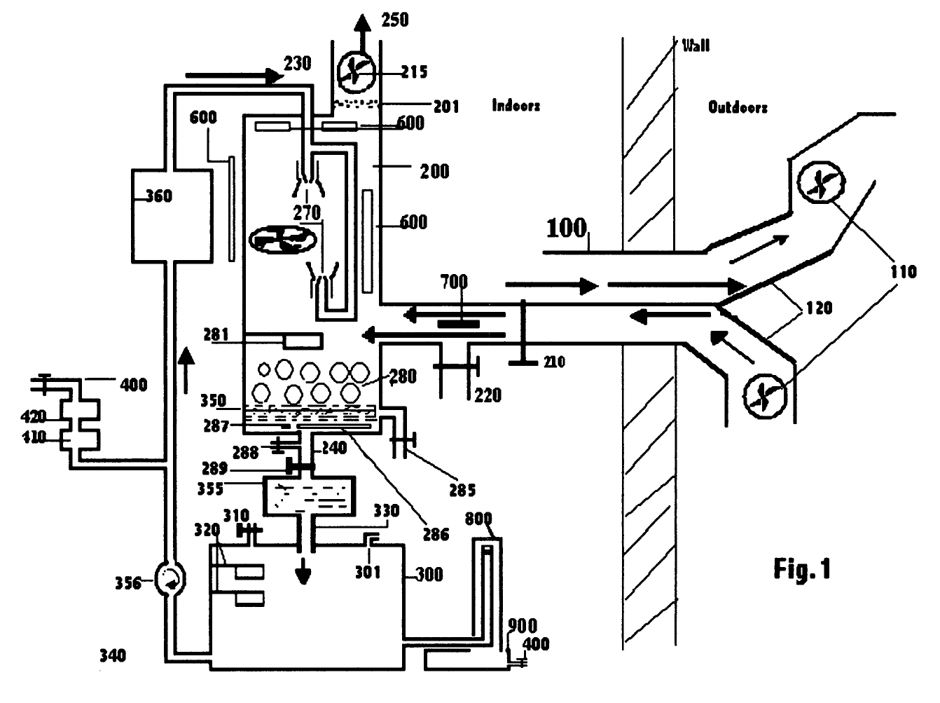

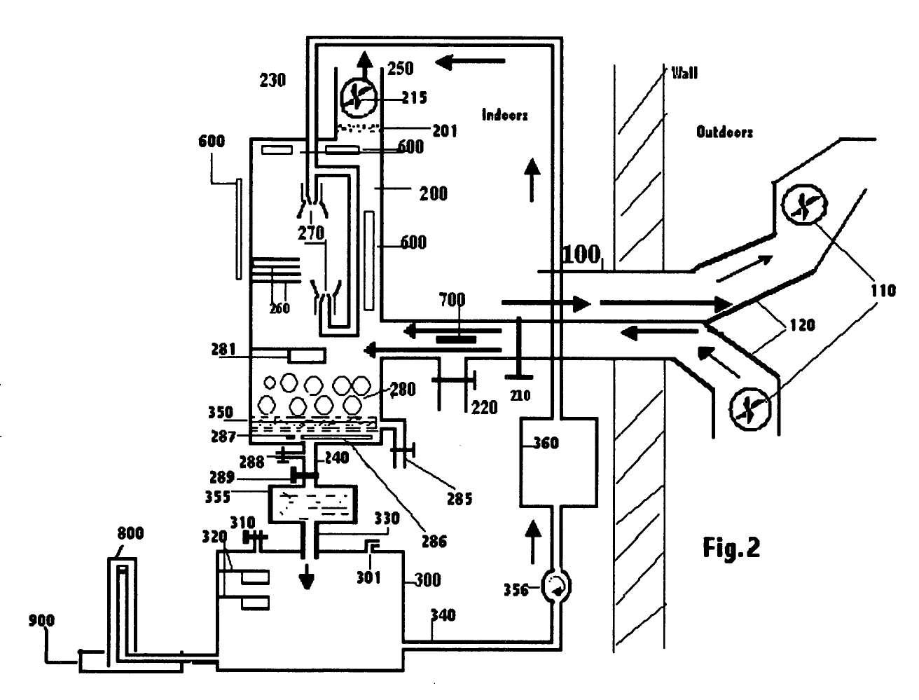

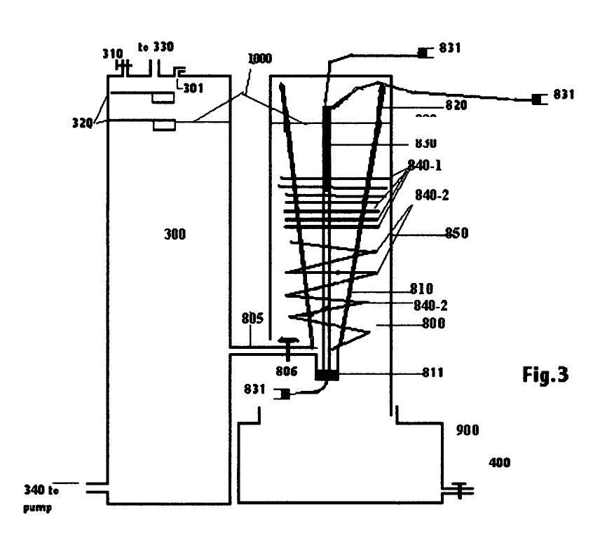

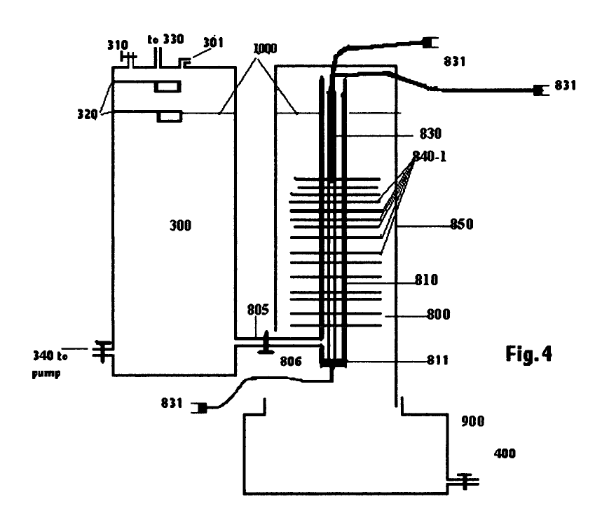

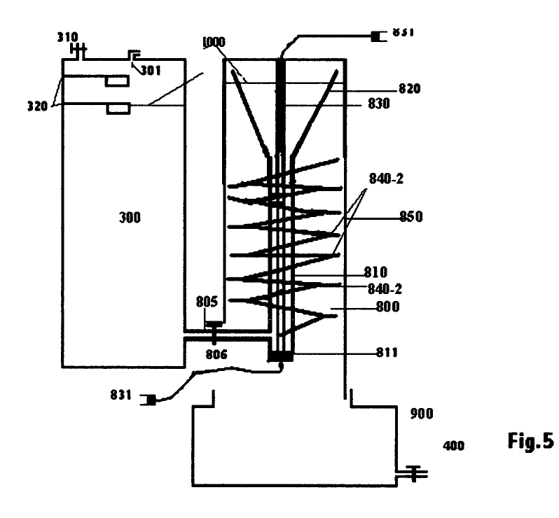

D. A novel design water distillation apparatus 800, attached to the water holding tank 300, to further purify the water for drinking. The tank 300 is also connected to the municipal water source 310, with means to control the water level in the tank. It is also vented 301 to the air. This tank 300 and apparatus 800 can alternatively be used as a separate embodiment as an independent freestanding device. See FIG. 1 through 4 for various embodiments. The distillation device comprises a pipe 805 attached approximately near the bottom of the tank to receive the water from the tank, and connected to a substantially vertical pipe 810. The pipe 810 is open at the top, and is optionally widened 820 at the top, making the top part a kind of a boiling vessel. The tank, the pipes 805 and 810 are therefore forming two communicating vessels, with equilibrium water level in the pipe 810 being the same as in the tank 300. The pipe 810 can be straight, spiral, or any shape, but preferably, the pipe 810 is straight to facilitate cleaning the accumulating scale. The said pipe 810 is either of the same diameter throughout, or is widened 820 at the top, The said pipe 810 has the outer surface of a simple regular pipe, or is shaped or lined with heat conducting rings 840-1, or spirals 840-2, or has curved, spiked, zigzag, spiral or other shape or combination of shapes for facilitating the heat transfer between the inside and the outside of the pipe, which said pipe 810 is closed at the bottom with a removable plug 811, and which plug can have a wire 831 going through to the heating element 830,

A heating element 830 is boiling the water at the top of the pipe, with the vapors escaping over the top of the pipe 810, where they are condensed on the way down on the outside surface of the pipe 810. This establishes a counter-flow heat exchange between the downward moving water vapors which are heating the incoming cold water moving up on the way to be distilled. The heating element is heating the top of the pipe. It is placed inside, or attached on the outside of the top of the pipe 810, and is connected to the electric or gas energy source from above or from below or from the side. In one embodiment, the connection to the electricity source is through the bottom of the pipe 810, in another, through the top, in yet another one, through the walls of the pipe. FIG. 7 shows how the heat can be supplied through the side, using a gas flame 860, that heats the heat-conducting pipe 830. The energy used to heat the water near the top of the pipe 810 can also be microwave, solar rays, or another form of radiation, when the cover 850 is made from a transparent material like a glass.

The inner surface of the pipe 810 is preferably smooth to facilitate cleaning from scale. The outer surface of the pipe 810 is optionally shaped or lined with metal rings 840-1, or preferably spirals 840-2, etc. to facilitate the heat transfer between the inside and outside of the pipe, and to channel the condensed water downwards along the pipe 810, and towards the distillate receiver vessel 900. The outer cover 850, which is closed at the top, and open to the atmosphere at the bottom, and which lets the condensed distilled water out into the vessel 900, and which is preferably made of glass, is enclosing the pipe 810. A slot is cut in the bottom wall of the cover 850 to accommodate the pipe 805 when the cover is lowered in its position, and to let the wire from for the heating element through. Optionally, the coils around the pipe 810 form such an enclosed vessel, then the enclosure 850 is not needed.

The inside of the 810 pipe is preferably packed with the water-conducting porous metal like metal sponge, to prevent circulation of water, and to increase heat transfer between the water and the walls, which metal will also serve as a receptor for the scale.

When the water evaporates from the 820 part of the pipe 810, fresh water is coming in from below from the water holding tank due to the law of communicating vessels. Therefore, the system is self-regulating, since the water level in tank 300 is controlled to be the same by a level control mechanism, which inputs water from the municipal water when the level goes down, thus assuring that the water in the 820 part keeps replenishing. Thus the rate of distillation is only a function of the amount of the heat energy that is supplied by the heating element.

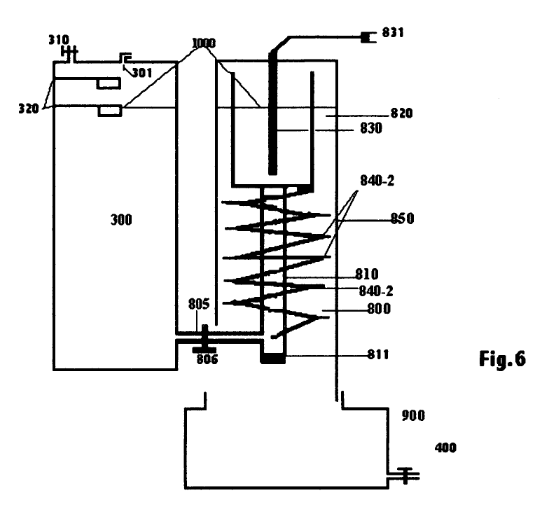

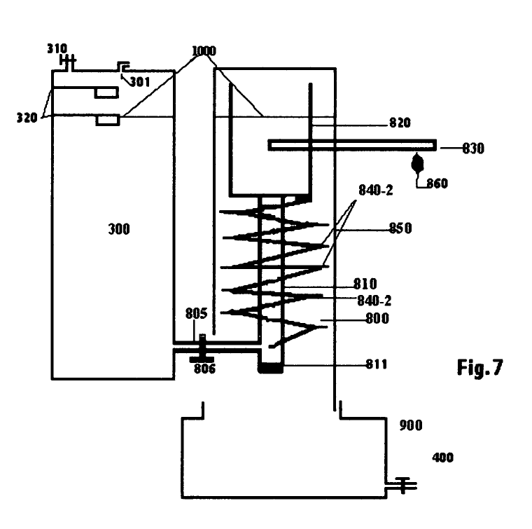

In the preferred embodiments, two examples of which are shown in FIG. 5 and FIG. 6, the pipe 810 is made of metal like stainless steel, copper, bronze and the like, and it has two parts, a straight thinner lower part, and a widened top part 820 which maximal diameter is about double to quadruple the diameter of the lower part, and the length is from 5 to 20 percent of the total pipe 810 length, and a plurality of heat conducting channels 840-2 is attached to the lower part of the pipe 810 on the outside in a spiral fashion, with the total width of such channels and the pipe 810 being between 2 and 10 percent wider than the width of the pipe 820, and wherein the outer cover 850 enclosing the pipe 810 is between 1 and 10 percent wider than the total width of the pipe 810 and the channels 840-2, which outer cover 850 is made from a transparent poorly heat conducting or insulating material like a glass, and wherein the heating element is of an electric resistance type, which is suspended or projected into part 820 from the top of the cover 850, through a sealed hole, or an IR heat source, which is suspended above the transparent top of the cover 850, and irradiating the inside of the pipe 820.

E. A drinking water dispensing outlet 400, which is drawing water from the recirculating system, or from the distillate receiver 900, with means 410 to additionally filter the water during dispensing, and (optionally) means 420 for heating or cooling the drinking water. The drinking water dispensing outlet 400 is connected anywhere in the water circulation path, but preferably to the distillate receiver 900, or to the outflow line from the tank towards the water contacting chamber,

F. A sensor and control system 500 to automatically control the operation of the apparatus to purify the air and provide desired indoor temperature and humidity, based on the indication of the sensors, comprising
means to control the temperature of the circulating water,
thermostat to control the temperature of the indoor air by controlling the temperature of the circulating water in the chamber,
means to control the indoor-outdoor air exchange rate, and the ratio between the incoming air stream from outdoors and the recirculation indoors air that goes through the water contacting chamber.
means to control the water circulation rate, and the air circulation rate,
means to control the height of the water dispersing devices 270,
air humidity sensor, water salinity sensor, carbon dioxide sensor, and carbon monoxide and air particulate sensors, and optional oxygen sensor, all tying into the computer and providing inputs for automatic intelligent control of the system through the computer.

The water contacting chamber can operate in a number of ways. In one design the air moves upward through the chamber, and the water downwards. This counterflow design provides a very efficient heat exchange.

In alternative embodiment both air and the water move downwards. In this way the air can be actually pumped by the water stream, through the Venturi effect pipe. (An example of such pipe is a vacuum aspirator, which uses tap water stream to pump air and create vacuum). Moving the water and air through the Venturi effect pipe also creates good mixing.

Another design is a fountain, with water and air going upwards while mixing and pumping air upwards through the Venturi effect pipe, with water subsequently falling back. Still another arrangement is a cross-flow, where the air moves horizontally through the falling water contacting. Still another design is by filling the water chamber with rocks, especially with limestone, or wood with water flowing or percolating down, and air upwards. Another design is to plant beneficial bacteria or plants in the chamber, which purify the air. Other arrangements and combinations are also possible within the scope of this invention. Each design has its advantages and disadvantages.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. I claim an apparatus comprising of an air-to-air heat exchanger 100 connecting the outdoor and indoor air through a plurality of channels, enabling moving indoors air outdoors, and outdoors air indoors and exchange of heat between the indoors air coming out and the incoming outdoors air, means 110 to move the air from indoors to outdoors, while simultaneously moving about the same amount of air in the opposite direction through the said heat exchanger 100, means 120 to physically separate and distance the air inlets and outlets on the outdoor end of heat exchanger to prevent the re-intake of the exhausted air, an air and water contacting chamber for contacting the incoming air from outdoors or recirculating air from indoors with water, comprising a water-impermeable enclosure 200, with baffles or channels 260, made of inorganic catalytic material, with limestone or other mineral filling 280, or other means to increase air-water contact area, which said chamber further comprises of, and further connected with a water circulation loop, comprising of means of dispersing the water in the chamber and mixing it with air, by either creating a mist or water droplet particles within the said chamber, or other means of increasing air-water contact area, one or more water dispersing devices 270, water filter 350, a water outlet 240, which is connected to a water filter 355, which is connected to a water holding tank 300, which is connected to a pump or pumps 356, to the water heater/cooler 360, which is connected to a pipe 230, which is connected to a water dispersing head 270, thus completing the water circulating loop, means 201 to contain the water droplets or mist within the said chamber, a vent and the valve 210 for the air incoming from the outdoors through the heat exchanger 100, a vent and the valve 220 for the incoming recirculating indoors air, or a three-way vent and a valve to control the amount and the ratio between the outdoors and indoors air entering the said chamber, a vent 250 for the air exiting the chamber towards indoors or towards the air ductwork, means 215 to move the air through the said chamber, one or more UV light sources 600 to irradiate the water in the contacting chamber from inside or outside, and a fully or partially reflective coating on the chamber walls to reflect the light and create multiple passes of light through the chamber, an air ionizer and ozone generator 700 in the chamber air intake path, to create an electric charge potential between the incoming air and the water in the chamber, and create ozone from oxygen in the air, a water tank 300, connected to the municipal water source 310, with one or more means to monitor and control the water level in the tank 320, which is also vented to the atmosphere through vent 301, and which said tank is also connected to the distillation apparatus 800, and to the water contacting chamber 200 through the inlet 330 and outlet 340, through a pump or pumps 356 to establish a circulation pattern of movement of water in the tank, and circulation between the tank and the water contacting chamber through heater/cooler 360, and the water filters 350 and 355, a heater and cooler means 360 to cool or heat the water flowing from the tank into the contacting chamber 200 using electric, gas, oil, solar energy, heat-pump, or another method, the water filter 350 to filter the water leaving the contacting chamber 200, comprising of one or more filtration means, a back-flushing system activated by a floating lever 281 when the water level above the filter bed in the water contacting chamber rises above the pre-set level, comprising of a water flow reversion switch or a mechanism that closes the valve 289 that goes to the water tank, and opens the valve 288 that is connected to a municipal water source, a vibrator 286 to vibrate or shake the filter bed during back-flushing, a heater 287 to heat the flushing water during back-flushing, a valve 285 to remove the flush water, a water filtration system 355 comprising of a water-permeable membrane or a fiber bed, and of ion exchanging membrane or fiber bed, with means to regenerate the said ion exchange bed, a water distillation apparatus 800, attached to the water holding tank 300, to further purify the water for drinking, a drinking water dispensing outlet 400, which is drawing water from the circulating system, or from the distillate receiver 900, with means 410 to additionally filter the water during dispensing, such as reverse osmosis unit, and means 420 for heating or cooling the drinking water, A sensor and control system 500 to automatically control the operation of the apparatus to purify the air and provide desired indoor temperature and humidity, based on the indication of the sensors, comprising air quality sensors, such as air and water temperature and humidity sensors, water pH and salinity sensors, carbon dioxide, carbon monoxide, oxygen and air particulate sensors, means to control the temperature of the circulating water, thermostat to control the temperature of the indoor air by controlling the temperature of the circulating water in the chamber, means to control the indoor-outdoor air exchange rate, and the ratio between the incoming air stream from outdoors and the recirculation indoors air that goes through the water contacting chamber, means to control the water circulation rate, means to control the height or the direction of the water dispersing devices 270.

2. An apparatus as claimed in claim 1, further defined as having an air-to-air heat exchanger of a counter-flow design, with adjustable height water dispersing device of the Ventury type, the baffles 260 made of dolomite, apatite, mica, hydrated alumina, baked clay, hydrotalcite or other minerals comprising of oxides, carbonates or phosphates of calcium, magnesium or aluminum, titania or vanadium-doped titania,

3. An apparatus as claimed in claim 1, further defined as having the baffles 260 made of titania or vanadium-doped titania

4. An apparatus as claimed in claim 1, further defined as having a water filter 350 to filter the water leaving the contacting chamber 200, comprising of a single or a multi-layer structure, or mixed bed, with gravel, crushed rocks, coarse sand, limestone, marble, chalk, dolomite, apatite, mica, hydrated alumina, baked clay, hydrotalcite or other minerals comprising of oxides, carbonates or phosphates of calcium, magnesium or aluminum, which minerals can be either untreated, or fully or partially calcined, or otherwise heat treated,

5. An apparatus as claimed in claim 1, further defined as having a water filtration system 355, utilizing activated carbon, and ion exchange materials, among them a filtration and ion exchange media made by grafting cationic and anionic species onto films or fibers made at least partially of cellulose, or covalently crosslinked cellulose, crosslinked starch, or other polysaccharides, crosslinked blends of anionically and cationically modified natural and synthetic polymers.

6. An apparatus as claimed in claim 1, further defined as having the heating and cooling unit 360 located below and near the air-to-air heat exchanger 100.

7. An apparatus as claimed in claim 1, further defined as having the substantially vertical arrangement of the following units: the filtration system 355 above the water holding tank 300, and the water filter 350 is above the filter 355 and is located at the bottom of the air and water contacting chamber 200,

8. An apparatus as claimed in claim 1, further defined as having the water holding tank 300, the filtration system 355, the water filter 350 and the air-water contacting chamber 200, all built as one relatively compact unit.

9. A distillation apparatus, suitable for water or other liquids, attached to a water holding vessel or tank, which apparatus and the tank are used either as a separate and independent free-standing device, or can be part of another apparatus like the distillation apparatus 800 and the tank 300 in claim 1, comprising of a water holding vessel or tank, which said tank is connected to the municipal water source 310, with one or more means to monitor and control the water level in the tank 320, which tank is also vented with the vent 301 to the atmosphere, a pipe 805, having two ends, one end attached to the water holding tank to receive the water from the tank, and the other end connected to the substantially vertical pipe 810, which said pipe 810 is open at the top and closed at the bottom with a removable plug 811, wherein the tank and the pipes 805 and 810 form two communicating vessels, with equilibrium water level 1000 in the pipe 810 being the same as in the tank 300, which said pipe 810 is either of the same diameter throughout, or is widened 820 at the top, and which said pipe 810 has the outer surface of a simple regular pipe, or is shaped or lined with heat conducting rings 840-1, or spirals 840-2, or has curved, spiked, broken, spiral or other shape or combination of shapes for facilitating the heat transfer between the inside and the outside of the pipe, and which removable plug 811 can have a wire 831 going through to the heating element 830, means 830 to boil the water at the top part 820 of the pipe 810, with the water vapors escaping over the top of the pipe and down on the outside of the pipe 810, where they are condensed on the way down on the outside surface of the pipe, thus establishing a counter-flow heat exchange between the downwardly moving water vapors and the upwardly moving cold water from the tank, said heating means comprise either infra-red, solar, microwave, or other radiation heat source, or an electric resistance heating element, with wires 831 supplying electrical energy either through the top, or through the bottom, or through the sides of the cover 850, outer cover 850 enclosing the pipe 810, with an air gap between the cover and the top and the walls of the pipe 810, with said cover having an upper end, and a lower end, with the upper end closed to the atmosphere, which can have a sealed hole for the wire that leads to the heating element 830 from above or from the side, and said cover is open to the atmosphere at the lower end, and lets the condensed distilled water fall into the distillate receiver vessel 900, which said cover has a slot at the lower part to accommodate the pipe 805 when the cover is lowered in position, and said cover can also accommodate the electric wire that leads to a heating element 830 from below.

10. A distillation apparatus as recited in claim 8, wherein the pipe 810 is made from iron, stainless steel, copper, bronze, or anodized aluminum.

11. A distillation apparatus as recited in claim 8, wherein the pipe 810 has two parts, a narrower lower part, and a widened top part 820 which maximal diameter is about double to quadruple the diameter of the lower part, and the length is from 5 to 20 percent of the total pipe 810 length, and a plurality of heat conducting channels 840-2 is attached to the lower part of the pipe 810 on the outside in a spiral fashion, with the total width of such channels and the pipe 810 being between 2 and 10 percent wider than the width of the pipe 820, and wherein the outer cover 850 enclosing the pipe 810 is between 1 and 10 percent wider than the total width of the pipe 810 and the channels 840-2, which outer cover 850 is made from a transparent poorly heat conducting or insulating material like a glass.

12. A distillation apparatus as recited in claim 8, wherein the heating element is of an electric resistance type, which is projected into part 820 from the top of the cover 850, through a sealed hole, or an infrared heat source, which is suspended above the transparent top of the cover 850, and irradiating the inside of the pipe 820, and the heating control means are provided.

13. A distillation apparatus as recited in claim 8, wherein the gap between the 820 part of the pipe 810 is 3 to 10 percent of the width of the 820 part, and the heat conducting channels 840-2 fit tightly within the cover 850, and the channels and the cover together form a plurality of closed spiral channels through which the vapors travel on the way down.

14. A distillation apparatus as recited in claim 8, wherein the cover 850 is made from double-walled evacuated insulating glass, or insulating foamed glass, or plastic.

15. A distillation apparatus as recited in claim 8, wherein the inside of the pipe 810 is packed with the water-conducting porous metal sponge

16. A method comprising of (a) exchanging the outdoors and indoors air with the outdoors air moving indoors and indoors air outdoors while efficiently exchanging the heat through the counter-flow heat exchanger, (b) filtering the incoming outdoors air by first creating electrical charge potential between air and water, then passing the air through the water contacting chamber, which traps the particulate pollutants in water droplets, and at the same time purifies the indoors air by (c) recirculating it through the same chamber, (d) disinfecting and oxidizing the pollutants by irradiating with the UV light the water and air mixture in the contacting chamber and (e) by percolating the air-water mixture through the limestone bed in the chamber, (f) heating or cooling the indoor air through controlling the temperature of the circulating water in the chamber, (g) humidifying or dehumidifying the indoor air through controlling the temperature of the circulating water in the chamber, and through controlling the height of the water-dispersing devices in the chamber, (h) condensing the water from the air by cooling the circulating water below the dew point, and (i) converting it into clean potable water through circulating it through the water filter system along with the rest of the water, between the water holding tank and the water contacting chamber, thus continuously purifying the water, (j) storing the water in the water holding tank, (k) removing ions by filtering through the ion exchange media, and by distilling the water through a distillation apparatus 800, (l) periodically back-flushing the filters and regenerating the ion exchange materials.

17. Zwitterionic polymers or blends or crosslinked blends of polymers, having positive and negative charges on the same chain, or on neighboring chains of crosslinked polymers, which are suitable for filtration and ion exchange purposes, and effective in removing partially oxidized pollutants from water, and toxic ions like perchlorate, lead, cadmium and arsenic and other ionic impurities, comprising of ionically and zwitterionically modified synthetic or natural polymers, films and fibers,

18. Zwitterionic polymers recited in claim 17, or blends or crosslinked blends of polymers, films and fibers derived from polysaccharides such as cellulose, crosslinked starch, chitine or chitosan, wherein such polymers, films and fibers are made by methods comprising of steps of (a) cyanopropylation of films or fibers from cellulose, starch, carboxymethylcellulose, and other natural or modified polysaccharides by addition of aqueous NaOH and acrylonitrile to such polysaccharides, followed by (b) the reduction of the nitrile group to amine, which amine groups are further quaternized by (c) alkylation with alkyl halide, dialkyl sulphate, 2-chloroacetic acid, or other alkylating agents or mixtures of agents, or made by the reaction of films or fibers from cellulose, starch, carboxymethylcellulose, and other natural or modified polysaccharides with (a) toluenesulphonyl chloride, thionyl chloride, or phosphorous oxychloride, followed by (b) the hydrohalogenation to obtain halogen-modified polysaccharides, followed by (c) amination with ammonia or amines, to obtain amino-functional polysaccharides, followed by (d) quaternization with methyl iodide, dimethyl sulphate, 2-chloroacetic acid, or other alkylating agents or mixtures of agents, or by reacting polyaziridine or polyvinylpyridine or ethylenediamine with carboxymethyl cellulose, and heating to crosslink, then reacting with the alkylating agent, or by reacting polyaziridine or polyvinylpyridine or ethylenediamine with the alkylating agent, followed by mixing with carboxymethyl cellulose and heating to crosslink, with such obtained fibers or films further optionally oxidized by (e) bromine water, or by hypochlorite in presence of bromide to oxidize the C(6)-carbinol group to carboxyl group, or made by mixing together separately made fibers or films of quaternized amino-functional cellulose or crosslinked starch, and fibers or films of carboxy-functional cellulose or crosslinked starch, which can be further coated onto or mixed with other materials to make a useable film or fibers.

19. The polymers recited in claim 17 wherein the ion exchanging fibers are made by mixing cationically modified fibers or films and anionically modified cellulose fibers or films, in presence of a non-ionic water-swellable polymer like hydroxyethyl cellulose or starch, and binder and crosslinkers, and react to cure.

20. The polymers recited in claim 17 wherein the zwitterionically modified fibers or films are made by reacting polyaziridine or polyvinylpyridine or ethylenediamine with carboxymethyl cellulose, then crosslinking, then reacting with the alkylating agent, or by reacting polyaziridine or polyvinylpyridine or ethylenediamine with the alkylating agent, followed by mixing with carboxymethyl cellulose and heating to crosslink.
